(19) United States
(12) Patent Application Publication
(10) Pub. No.: US 2005/0211056 A1
(43) Pub. Date: Sep. 29, 2005

(54) Bagpipe blow resistance training device

(76) Inventor: Michael Craig Copeland, Highland Village, TX (US)

Correspondence Address: MICHAEL C. COPELAND, 400 PATRICIA, HIGHLAND VILLAGE, TX, 75077, US

(21) Appl. No.: 11/075,449

(22) Filed: Mar. 7, 2005

Related U.S. Application Data
(60) Provisional application No. 60/550,943, filed on Mar. 8, 2004.

(51) Int. Cl. G10D 11/00

(52) U.S. Cl. 84/375

(57) ABSTRACT

The invention is an apparatus for the practice of perfecting the blowing technique of a woodwind instrument, specifically bagpipes. The device is designed to resemble the mouthpiece of a bagpipe and chanter, having a round elongated and narrow blowpipe similar to most bagpipes. The device allows the user to turn a dial that will in turn change the resistance of the air passing through the device as the user blows. The device may be dialed so that air passes freely with minimal resistance for a beginner and may later be dialed as to increase the resistance as the user becomes more competent in blowing and thereby has more resistance causing the user to build up his/her ability in blowing against a simulated firmer reed.

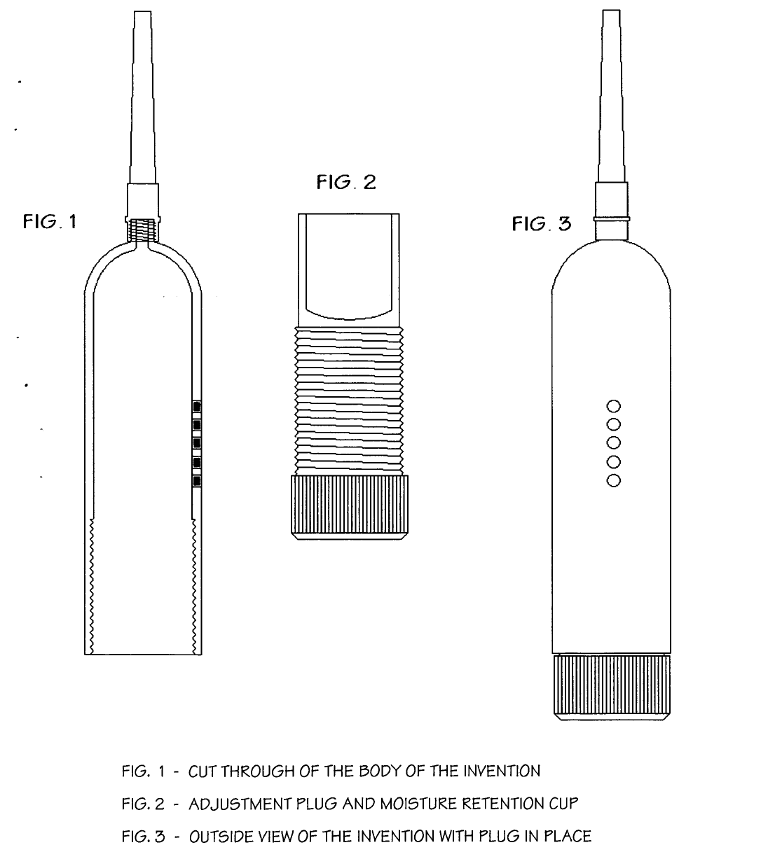

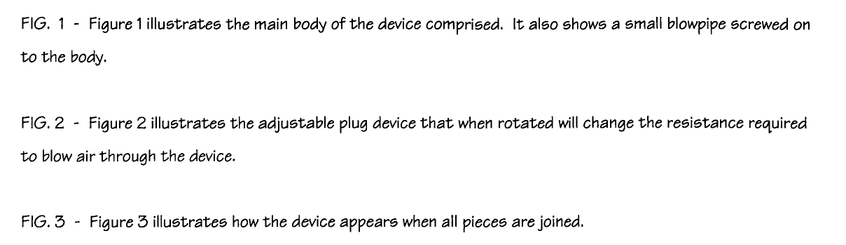

### FIELD OF THE INVENTION

The invention strengthens a musician's ability to blow various strength reeds.

### BACKGROUND OF THE INVENTION

The need for musicians to be able to blow various strength reeds is an absolute necessity to all musicians, especially those playing bagpipes. This device will allow these musicians to practice and strengthen their ability at times and locations when playing their instrument would have made the ability to practice impossible or impractical.

### SUMMARY OF THE INVENTION

The invention has a mouthpiece that is commonly found on all bagpipes and bagpipe practice chanters. The body of the invention is round and made from plastic. The body of the invention has a series of holes of specific sizes and at specific placements in the middle portion of the body. There is a lower adjustment plug that is made from plastic. That screws into the body of the invention. When fully tightened in the body of the invention, the body is airtight. When loosened almost all the way out, air blow through the mouthpiece flows easy through the invention. The correct use of this invention is to initially begin using the invention with the adjustment plug fully loosened. As the musician begins to build his respiratory skills, he can adjust the adjustment plug slightly tighter to increase the resistance required to blow air through the invention. There are no numbered adjustments so that musicians can adjust the invention to meet his/her needs by turning the adjustment plug as little or as much as desired. The adjustment plug has continuous threads resembling a screw so that minute adjustments are possible. The adjustment plug fits snugly inside the body of the invention. This firmness allows the user to maintain the desired setting after putting the invention down and coming back to it later. The resistance that the user feels when blowing the invention is another indicator the user can use. Even if the adjustment plug has not been moved, but the device blows too easily, the user can quickly and easily increase the resistance of the invention for the desired strength. The user can temporarily increase the resistance for a short period of time to challenge his respiratory skills and then easily decrease the resistance to a preferred level to resume continued practice.

1. A device for increasing the musician's ability to blow woodwind reeds of various strengths from soft/easy to hard/very firm by use of repeated training with this invention when use of the instrument itself would have been impossible or impractical.
